(19) United States
(12) Patent Application Publication
(10) Pub. No.: US 2007/0189530 A1
(43) Pub. Date: Aug. 16, 2007

(54) Management system for digital broadcast rights and a method thereof

(76) Inventors: Chia-Kai Liang, Taipei (TW); Chia-Chu Liu, Taipei (TW); Homer Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,056

(22) Filed: Mar. 8, 2006

(30) Foreign Application Priority Data
Oct. 18, 2005 (TW) 094136416

(51) Int. Cl. H04N 7/167

(52) U.S. Cl. 380/200

(57) ABSTRACT

A management system for digital broadcast rights and a method thereof, which applies to a digital video broadcasting system and utilizes the function of a multimedia home platform; when the multimedia data is intended to record or replay, the user's data will be analyzed to determine whether the user is allowed to use the multimedia data; further, encryption and decryption processes are used to monitor and control the record and replay processes of the multimedia data and protect the digital broadcast rights of the multimedia data lest it be unrestrictedly used or duplicated as one pleases.

### BACKGROUND OF THE INVENTION

1. Field of the Invention

The present invention relates to a digital rights management system, which applies to a digital video broadcasting system, particularly to a management system for digital broadcast rights and a method thereof.

2. Description of the Related Art

The so-called DRM (Digital Rights Management) system is a mechanism, which utilizes various technologies, such as Cryptography, Conditional Access, Digital Watermarking, and Biometric Identification, to protect digital data from being unrestrictedly used or spread as one pleases. Via the DRM system, the rights of users, creators, and service providers can be clearly defined and securely protected.

The television is a main source of multimedia audio/video data in a family. At present, the DVB system (Digital Video Broadcasting System) still lacks a dedicated DRM system but just follows the conventional CA (Conditional Access) technology used in the satellite television. However, after multimedia audio/video data has passed the gate of CA, there is no more protection at all, and the user can unrestrictedly duplicate and spread the multimedia data as he pleases. The high-quality audio/video data transmitted by the DVB system is digital; therefore, with the digital recording technology, it is easily that one duplicates the original digital audio/video data to obtain a duplicate files exactly the same as the original one.

For the time being, many research organizations and government organizations are conscious of the importance of the aforementioned problem. The TIRAMISU technology (the Innovative Rights and Access Management Inter-platform Solution) being developed by European Union is the very example of that, wherein DRM function is intended to add to the DVB system. The xCP home network proposed by IBM and the Smartright system proposed by Thomson Inc. intend to utilize the Smart Card—a high-security storage and execution device—to monitor and control the usage and spread of home-used digital multimedia. Japanese government also has instructed her domestic industries that the video recorder should meet the requirements of protecting the rights of creators, broadcast companies, and users.

Therefore, it can be concluded from the above mentioned discussion that developing a mature and expandable management system for digital broadcast rights is necessary and urgent.

### SUMMARY OF THE INVENTION

The primary objective of the present invention is to provide a management system for digital broadcast rights and a method thereof, which applies to a digital video broadcasting system and can provide more protection for multimedia data without any extra hardware lest the multimedia data be unrestrictedly used or duplicated as one pleases.

Another objective of the present invention is to provide a management system for digital broadcast rights and a method thereof, which utilizes MHP (Multimedia Home Platform) function to make the digital video receiving unit of DVB system be a platform able to execute programs to monitor the record and replay of multimedia data, wherein not only the multimedia data itself and the user's rights are authenticated but also the encryption and digital watermarking mechanisms are also used in order to promote the system safety.

To achieve the above mentioned objectives, the management system for digital broadcast rights of the present invention comprises: a digital video receiving unit, a user authentication unit, a digital monitoring unit, and a storage unit. The digital video receiving unit is used to receive at least one multimedia data, which comprises a rights expression data. The user authentication unit is used to store a user authentication data. The digital monitoring unit is used to determine whether the user authentication data conforms to the rights expression data of the multimedia data; if it is confirmed, the digital monitoring unit encrypts the multimedia data and creates an encryption key corresponding to the multimedia data and then provides the encryption key and the rights expression data for the user authentication unit. The storage unit is used to store the encrypted multimedia data.

When the encrypted multimedia data stored in the storage unit is intended to replay, the digital monitoring unit firstly reads the user authentication data, the rights expression data of the multimedia data and the encryption key, which are stored in the user authentication unit, and then determines whether the multimedia data is allowed to replay, and if it is confirmed, the digital monitoring unit utilizes the encryption key to decrypt the encrypted multimedia data, and then, the multimedia data is replayed.

The present invention also proposes a management method for digital broadcast rights, which comprises the following steps: firstly, receiving at least one multimedia data, which comprises a rights expression data, and reading a user authentication data from a user authentication unit; next, determine whether the user authentication data of the user authentication unit conforms to the rights expression data of the multimedia data; if it is confirmed, encrypting the multimedia data, creating an encryption key corresponding to the multimedia data; next, storing the encryption key and the rights expression data into the user authentication unit; and then, storing the encrypted multimedia data into a storage unit.

When the encrypted multimedia data stored in the storage unit is intended to replay, the user authentication data, the rights expression data of the multimedia data, and the encryption key, which are stored in the user authentication unit, are read out to determine whether the multimedia data is allowed to replay, and if it is confirmed, the encryption key is used to decrypt the encrypted multimedia data, and then, the multimedia data is replayed.

To enable the objectives, characteristics and efficacies of the present invention to be more easily understood, the present invention is to be described below in detail in cooperation with the drawings.

### BRIEF DESCRIPTION OF THE DRAWINGS

FIG. 1 is a diagram schematically showing the management system for digital broadcast rights of the present invention.

FIG. 2 is a diagram schematically showing one embodiment of the management system for digital broadcast rights of the present invention.

FIG. 3 is a diagram schematically showing the process of monitoring and controlling video-recording operation in one embodiment of the management system.

FIG. 4 is a diagram schematically showing the process of monitoring and controlling display operation in one embodiment of the management system.

### DETAILED DESCRIPTION OF THE INVENTION

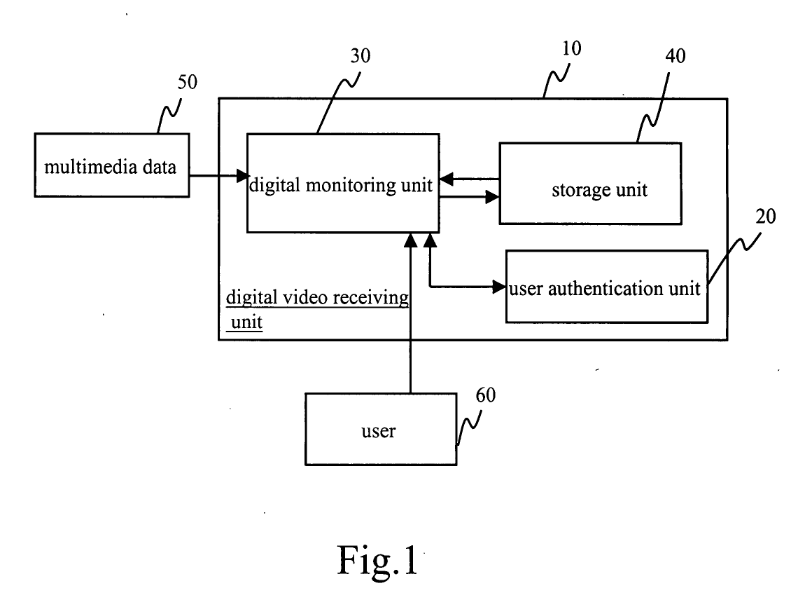

Refer to FIG. 1 a diagram schematically showing the management system for digital broadcast rights of the present invention. The management system for digital broadcast rights of the present invention comprises: a digital video receiving unit 10, a user authentication unit 20, a digital monitoring unit 30, and a storage unit 40. The digital video receiving unit 10 may be a Set Top Box (STB) of a digital television and can receive multimedia data 50 via a network. The user authentication unit 20 may be a Smart Card and stores authentication and identification data, such as user authentication data. The storage unit 40 may be a hard disc or a Digital Video Disc (DVD) and stores encrypted multimedia data 50. The digital monitoring unit 30 can operate in the digital video receiving unit 10.

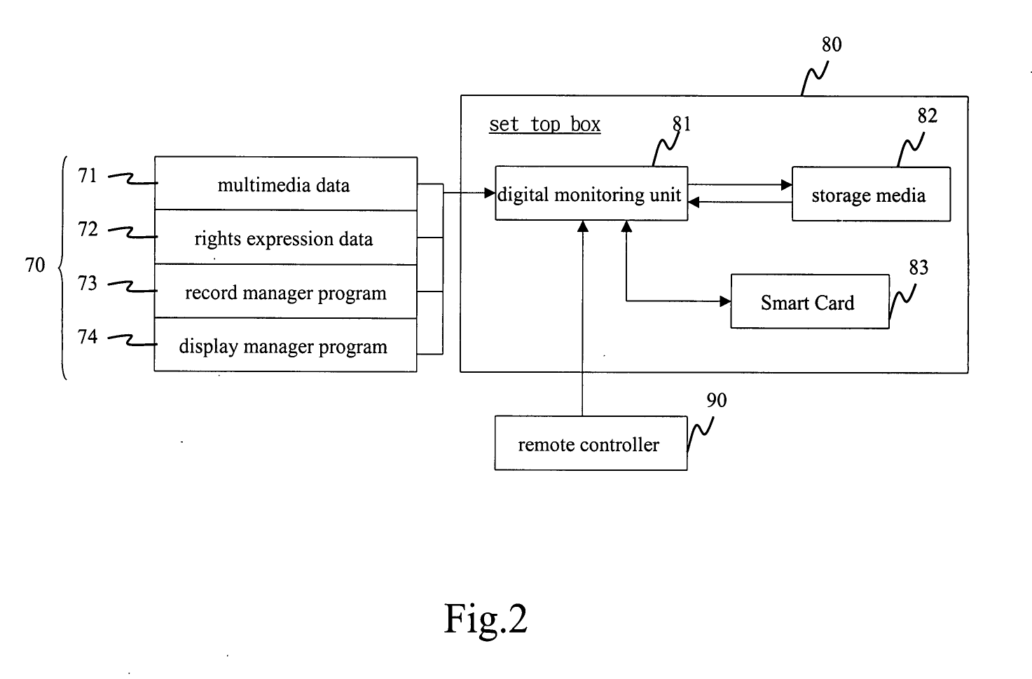

Refer to FIG. 2 for one embodiment of the management system for digital broadcast rights of the present invention. In this embodiment, the digital monitoring unit 81 can utilize a record manager program 73 and a display manager program 74 to execute its task.

In this embodiment, the management system for digital broadcast rights is based on a DVB system (Digital Video Broadcasting System), and no matter whether the broadcast is via a terrestrial data line or a satellite terrestrial link, the system of the present invention can work well. According to the definition of DVB system, in addition to multimedia data 71 of audio/video data and basic data, this embodiment further add RED 72 (Rights Expression Data), a record manager program 73 and a display manager program 74 into the transport stream 70. The record manager program 73 and the display manager program 74 are executed according to the definition of DVB-MHP (Multimedia Home Platform), and the rights expression data 72 is a data related to the rights of the multimedia data 71. All of them are described below in detail.

To protect the multimedia data 71 for creators or broadcast service providers, the rights expression data 72 is broadcast together with the multimedia data 71 to each user. A variety of multimedia data-related rights are defined in the rights expression data 72, including: conditions of the record-allowable user, record/spread conditions, valid replay periods, allowed replay times, publisher data, and protection mechanisms. The format of the multimedia data 71 can be defined by the creator or the broadcast service provider, or adopts international standards in order to promote the system compatibility. In the future, the unified international standard may be REL (Rights Expression Language) in MPEG part-5, which utilizes XML format to define the rights of multimedia data and is compatible with other portions of MPEG 21.

The record manager program 73 is also broadcast together with the multimedia data 71; however, unlike the rights expression data 72, the record manager program 73 is not dedicated to a specific multimedia data 71, and the broadcast service provider can utilize an identical record manager program 73 to protect all multimedia data 71. The record manager program 73 is designed according to the DVD-MHP definition and can be executed in a set top box 80 having MHP. The record manager program 73 utilizes an MHP interface to control the operation of the set top box 80, including: recording the broadcast multimedia data 71, reading the rights expression data 72, reading/writing a Smart Card 83, and protecting/encrypting recorded multimedia data 71.

The display manager program 74 is also broadcast together with the multimedia data 71; however, unlike the rights expression data 72, the display manager program 74 is not dedicated to a specific multimedia data 71, and the broadcast service provider can utilize an identical display manager program 74 to protect all multimedia data 71. The display manager program 74 is designed according to the DVD-MHP definition and can be executed in the set top box 80 having MHP. The display manager program 74 utilizes an MHP interface to control the operation of the set top box 80, including: replaying the multimedia data 71 recorded beforehand, reading the rights expression data 72 saved beforehand, reading/writing the Smart Card 83, and decrypting recorded multimedia data 71.

The entire system utilizes the above mentioned data and programs to operate. When the user intends to record, the system utilizes the record manager program 73 to protect broadcast multimedia data 71. When the user intends to replay the multimedia data 71 recorded beforehand, the system utilizes the display manager program 74 to protect broadcast multimedia data 71.

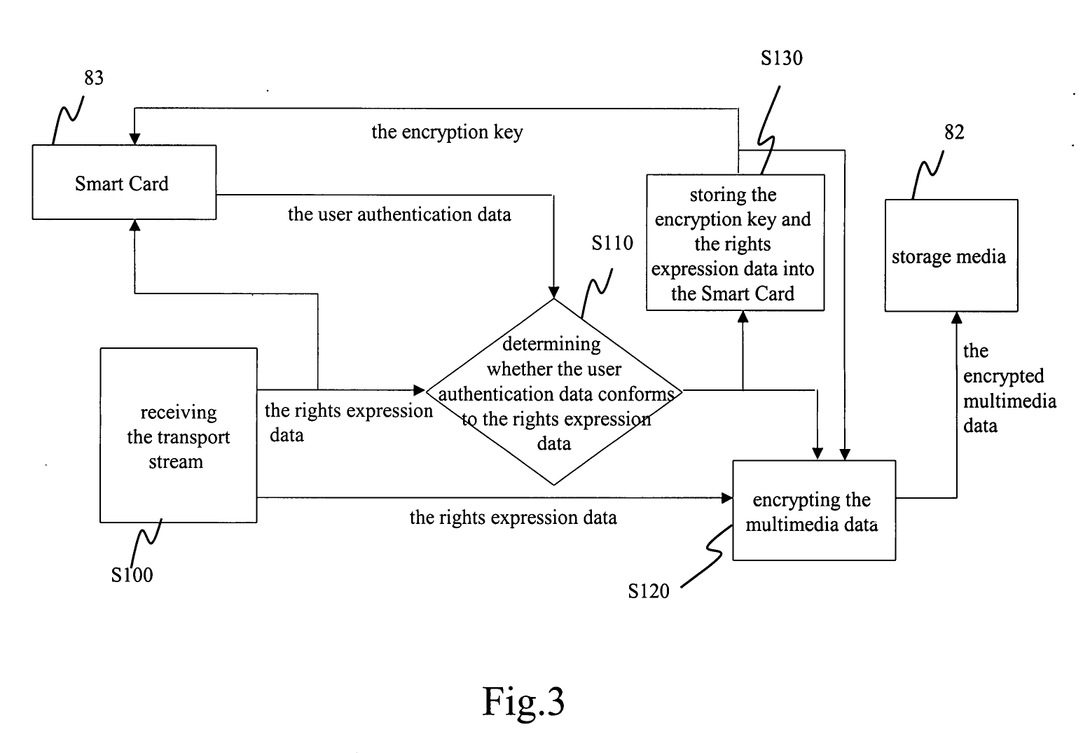

Refer to FIG. 2 and FIG. 3. FIG. 3 is a diagram schematically showing the process of monitoring and controlling video-recording operation in this embodiment. When the multimedia data protected by the system is displayed, the record manager program 73 begins to operate. The process comprises the following steps:

Step S100

The user utilizes a remote controller 90 to instruct the set top box 80 to record multimedia data from the transport stream 70.

Step S110

The record manager program 73 detects this instruction and then refers to the Smart Card 83 to determine whether the user authentication data stored in the Smart Card 83 conforms to the rights expression data 72 of the multimedia data 71.

Step S120

If the record manager program 73 confirms the qualification of the user, the record manager program 73 begins to encrypt the broadcasting multimedia data 71.

Step S130

The record manager program 73 stores the encryption key and the rights expression data into the Smart Card 83 as a certificate for accessing the multimedia data 71. Lastly, the record manager program 73 stores the encrypted multimedia data 71 into the storage media 82.

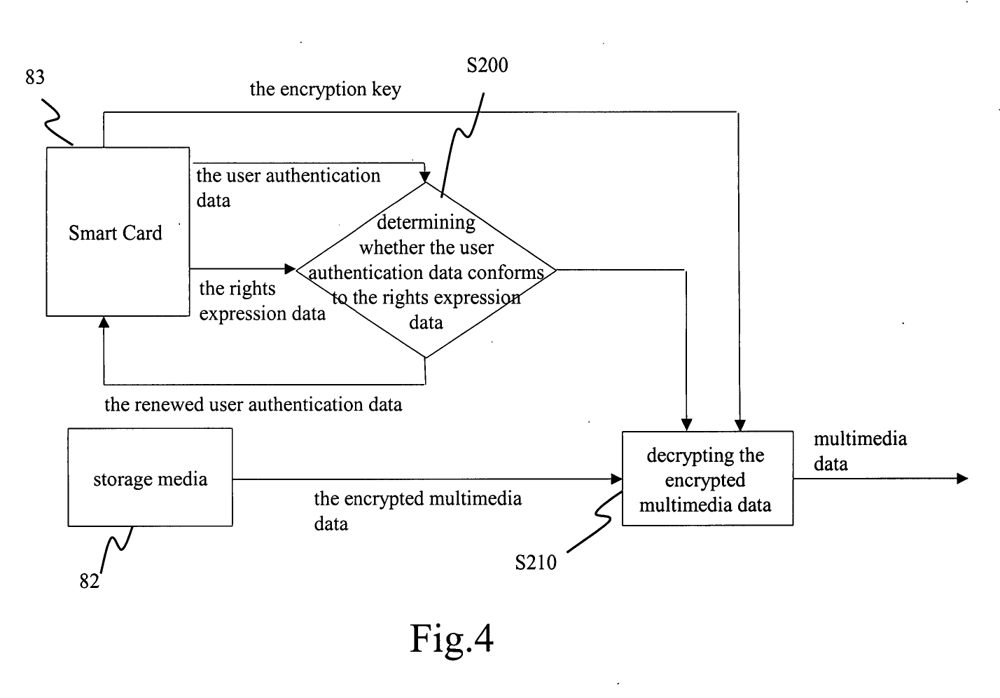

Refer to FIG. 4 a diagram schematically showing the process of monitoring display operation in this embodiment. The process comprises the following steps:

Step S200

The user utilizes a remote controller 90 to instruct the set top box 80 to replay the multimedia data 71 recorded beforehand. The display manager program 74 detects this instruction and begins to read the user authentication data, the rights expression data 72 of the multimedia data 71, and the encryption key, which are saved in the Smart Card 83, in order to determine whether to replay the multimedia data 71 according to whether the user authentication data conforms to the rights expression data 72.

Step S210

If the display manager program 74 confirms that replaying the multimedia data 71 is allowable, the display manager program 74 begins to read the encrypted multimedia data 71 saved in the storage media 82 and then utilizes the encryption key saved in the Smart Card 83 to decrypt the encrypted multimedia data 71 and then replays the multimedia data 71.

When recording multimedia data, the creator or the broadcast service provider may add a digital watermark to the multimedia data in order to trace the distributor. The digital watermark should comprise user data. Any related algorithm may be applied to this method.

If the display manager program 74 denies the request of replaying the multimedia data 71, it will also intend to encode and read the contents of the digital watermark. If the multimedia data 71 is restricted on replay times, the display manager program 74 will update the accumulated replay times recorded in the Smart Card.

Many encryption algorithms can be applied to the management system for digital broadcast rights and the method thereof to protect multimedia data. Some algorithms need a very high calculation quantity and may also need extra auxiliary hardware; therefore, they are not suitable for the system of the present invention. All fast encryption algorithms or effective multimedia-related algorithms can be used in the system of the present invention.

Further, if the storage media can be transferred to another hardware, such as a personal computer or a mobile phone, the hardware should be able to read the user authentication unit and should have the display manager program that can be executed in this platform. It is unnecessary for the display manager program used in another platform to meet MHP (Multimedia Home Platform) regulations.

Besides, the Conditional Access system originally existing in DVB (Digital Video Broadcasting) system does not conflict with the system of the present invention but can provide more protection for broadcast multimedia data.

In summary, the present invention proposes a management system for digital broadcast rights and a method thereof, which utilizes MHP (Multimedia Home Platform) function to make the digital video receiving unit of a DVB system be a platform able to execute programs, wherein DRM executive programs and the rights definition can be downloaded via broadcast channels of the DVB system, and the safety mechanism of MHP-STB can also provide security and reliability for programs. Further, when multimedia data pass the DRM system and enter into a storage device, the downloaded programs can be used to encrypt the multimedia data or put a watermark on the multimedia data. Those critical data, such as the authentication data of the user or the multimedia data can be accessed in a Smart Card, so that the user can easily carry about and conveniently utilize those critical data. Besides, in the embodiment of the present invention, the digital rights management mechanism is implemented with software; therefore, if some portion of the system function is damaged, the related portion of the programs can be easily modified and updated via the broadcast system, and no hardware modification is needed.

The present invention has been disclosed above with those embodiments; however, they are not intended to limit the scope of the present invention. Any equivalent modification and variation according to the spirit of the present invention is to be included within the scope of the claims of the present invention, which are to be stated below.

What is claimed is:

1. A management system for digital broadcast rights, comprising:
a digital video receiving unit, receiving at least one multimedia data, which comprises a rights expression data;
a user authentication unit, storing a user authentication data;
a digital monitoring unit, used to determine whether said user authentication data of said user authentication unit conforms to said rights expression data of said multimedia data, encrypting said multimedia data, creating an encryption key corresponding to said multimedia data, and providing said encryption key and said rights expression data for said user authentication unit; and
a storage unit, used to store said encrypted multimedia data.

2. The management system for digital broadcast rights of claim 1, wherein said storage unit is a hard disc or a Digital Video Disc.

3. The management system for digital broadcast rights of claim 1, wherein said digital monitoring unit can put a digital watermark on said multimedia data.

4. The management system for digital broadcast rights of claim 1, wherein said user authentication unit is a Smart Card.

5. The management system for digital broadcast rights of claim 1, wherein said digital video receiving unit is a Set Top Box of a digital television.

6. The management system for digital broadcast rights of claim 1, wherein said digital monitoring unit further comprises a record manager program and a display manager program.

7. The management system for digital broadcast rights of claim 6, wherein said record manager program confirms that said user authentication data of said user authentication unit conforms to said rights expression data of said multimedia data and then to encrypt said multimedia data and save the encrypted multimedia data into said storage unit.

8. The management system for digital broadcast rights of claim 6, wherein before replaying said encrypted multimedia data stored in said storage unit, said display manager program reads said user authentication data, said rights expression data of said multimedia data, and said encryption key, which are stored in said user authentication unit and determines whether said user authentication data conforms to said multimedia data, and if it is confirmed, said display manager program utilizes said encryption key to decrypt said encrypted multimedia data.

9. The management system for digital broadcast rights of claim 6, wherein said record manager program and said display manager program together with said multimedia data are simultaneously received by said digital video receiving unit in order to control the record and replay of said multimedia data.

10. A management method for digital broadcast rights, comprising the following steps:
receiving at least one multimedia data, which comprises a rights expression data, and reading a user authentication data from a user authentication unit;
determining whether said user authentication data conforms to said rights expression data of said multimedia data;
confirming that said user authentication data conforms to said rights expression data of said multimedia data, encrypting said multimedia data, creating an encryption key corresponding to said multimedia data, and providing said encryption key and said rights expression data for said user authentication unit; and
storing said encrypted multimedia data.

11. The management method for digital broadcast rights of claim 10, further comprising a step of putting a digital watermark on said multimedia data after said step of confirming that said user authentication data conforms to said rights expression data of said multimedia data.

12. The management method for digital broadcast rights of claim 10, wherein said user authentication unit is a Smart Card.

13. The management method for digital broadcast rights of claim 10, further comprising a step of reading said user authentication data, said rights expression data of said multimedia data, and said encryption key, which are stored in said user authentication unit after said step of storing said encrypted multimedia data.

14. The management method for digital broadcast rights of claim 13, further comprising a step of determining whether said user authentication data conforms to said multimedia data after said step of reading said user authentication data of said user authentication unit, said rights expression data of said multimedia data, and said encryption key, which are stored in said user authentication unit.

15. The management method for digital broadcast rights of claim 14, further comprising a step of utilizing said encryption key to decrypt said encrypted multimedia data after said step of determining whether said user authentication data conforms to said multimedia data.

16. The management method for digital broadcast rights of claim 15, further comprising a step of replaying the decrypted multimedia data after said step of utilizing said encryption key to decrypt said encrypted multimedia data.

17. The management method for digital broadcast rights of claim 15, wherein said step of receiving at least one multimedia data includes a step of receiving a display manager program in order to control the replay of said encrypted multimedia data.

18. The management method for digital broadcast rights of claim 17, wherein the step of before replaying said encrypted multimedia data stored in said storage unit, said display manager program reads said user authentication data, said rights expression data of said multimedia data, and said encryption key, which are stored in said user authentication unit and determines whether said user authentication data conforms to said multimedia data, and if it is confirmed, said display manager program utilizes said encryption key to decrypt said encrypted multimedia data.

19. The management method for digital broadcast rights of claim 10, wherein said step of receiving at least one multimedia data includes a step of receiving a record manager program in order to control the record of said multimedia data.

20. The management method for digital broadcast rights of claim 19, wherein said record manager program is used to execute said steps of determine whether said user authentication data conforms to said rights expression data of said multimedia data and encrypting said multimedia data, and is used to control said step of storing said encrypted multimedia data.
